(19) United States
(12) Patent Application Publication
(10) Pub. No.: US 2020/0018857 A1
(43) Pub. Date: Jan. 16, 2020

(54) Optical Sensor System

(71) Applicant: SiLC Technologies, Inc., Monrovia, CA (US)

(72) Inventors: Dazeng Feng, El Monte, CA (US); Mehdi Asghari, La Canada Flintridge, CA (US); Bradley Jonathan Luff, La Canada Flintridge, CA (US)

(21) Appl. No.: 16/113,364

(22) Filed: Aug. 27, 2018

Related U.S. Application Data
(60) Provisional application No. 62/697,266, filed on Jul. 12, 2018.

(51) Int. Cl. G01S 17/58; G01S 17/08; G01S 7/481; G01S 17/93

(52) U.S. Cl. CPC G01S 17/58; G01S 17/936; G01S 7/4818; G01S 17/08

(57) ABSTRACT

A LIDAR system has a LIDAR chip that includes an optical port through which a light signal exits from the optical chip. The light signal includes data from which a value of one or more components can be approximated. The one or more components selected from a group consisting of a relative distance between the LIDAR chip and an object located off the LIDAR chip, and a radial velocity between the object and the LIDAR chip.

### RELATED APPLICATIONS

This application claims the benefit of U.S. Provisional Patent Application Ser. No. 62/697,266, filed on Jul. 12, 2018, entitled “Optical Sensor System,” and incorporated herein in its entirety.

### FIELD

The invention relates to optical devices. In particular, the invention relates to LIDAR chips.

### BACKGROUND

There is an increasing commercial demand for 3D sensing systems that can be economically deployed in applications such as ADAS (Advanced Driver Assistance Systems) and AR (Augmented Reality). LIDAR (Light Detection and Ranging) sensors are used to construct a 3D image of a target scene by illuminating a field of view with light and measuring the returned signal. Frequency Modulated Continuous Wave (FMCW) is an example of a coherent detection method the can be used to measure distance and/or radial velocity of reflecting objects in the field of view. FMCW techniques have reduced sensitivity to ambient light and light from other LIDAR systems.

A vehicle can include one or more LIDAR chips. For instance, a car that has an ADAS (Advanced Driver Assistance System) and/or a self-driving vehicle can have a LIDAR system that includes one or more of the LIDAR chips. The LIDAR chip is operated by electronics that are distributed in the vehicle. For instance, a portion of the electronics are generally local to the LIDAR chip while another portion of the electronics are included in central electronics for the vehicle. In addition to processing signals from one or more LIDAR chips, the central electronics generally process signals from a variety of different sensors in the vehicle. For instance, the central electronics can process signals from cameras, inertial sensors, rotational sensors, radar, infra-red (IR) cameras, radionavigation systems such as the Global Positioning System (GPS), and acoustic sensors such as microphones.

Due to the configuration of many vehicles, a communications link carries data from the LIDAR chip to the central electronics. The communications link often needs to make a circuitous route from a LIDAR chip to the central electronics. The communication link often needs to carry digital and/or analog signals. When the communications link carries digital signals, the communications link generally needs to carry the signals at a data rate of more than 0.1 Gbps, more than 10 Gbps or even more than 20 Gbps for a length greater than 5 m, 10 m, or even 20 m as can occur in vehicles such a large trucks. When the communications link carries analog signals, the communications link generally needs to carry the analog signals at a rate that is equivalent to these data rates.

Copper wires are often ineffective for carrying data under these conditions. Additionally, copper wires and cables that can carry data at these rates over these distances add greater weight to an autonomous vehicle and also generate more electromagnetic interference (EM) and are more susceptible to EMI from other data signals. This is important for all autonomous vehicles, but will be especially important for airborne autonomous vehicles.

As a result, there is a need for a LIDAR system that is capable of use with applications such as vehicles.

### SUMMARY

A LIDAR system has a LIDAR chip that includes an optical port through which a light signal exits from the optical chip. The light signal includes data from which a value of one or more components can be approximated. The one or more components selected from a group consisting of a relative distance between the LIDAR chip and an object located off the LIDAR chip, and a radial velocity between the object and the LIDAR chip.

A LIDAR system has a LIDAR chip that includes an optical port through which a light signal exits from the optical chip. The light signal includes light reflected by an object located off the chip.

### BRIEF DESCRIPTION OF THE FIGURES

FIG. 1 is a top view of a LIDAR chip.

FIG. 2 is a cross-section of a LIDAR chip according to FIG. 1 constructed from a silicon-on-insulator wafer.

FIG. 3 illustrates the LIDAR chip of FIG. 1 used with an off-chip scanning mechanism.

FIG. 4 illustrates the LIDAR chip of FIG. 1 used with another embodiment of an off-chip scanning mechanism.

FIG. 5 is a cross section of the LIDAR chip of FIG. 1 having an integrated scanning mechanism.

FIG. 6A illustrates the chip of FIG. 1 modified to include multiple different balanced detectors for further refining data generated by the chip.

FIG. 6B provides a schematic of electronics that are suitable for use with the chip of FIG. 6A.

FIG. 6C is a graph of magnitude versus frequency. A solid line on the graph shows results for a Complex Fourier transform performed on output generated from the LIDAR chip of FIG. 6B.

FIG. 7 is a diagram of a vehicle that includes one or more LIDAR chips.

FIG. 8 illustrates a LIDAR system where electronics are distributed among remote electronics and local electronics.

FIG. 9 illustrates an embodiment of a LIDAR system where optical components are distributed among remote electronics and a LIDAR chip.

FIG. 10 illustrates yet another embodiment of a LIDAR system where optical components are distributed among remote electronics and a LIDAR chip.

### DESCRIPTION

A LIDAR system includes a communication link that includes or consists of one or more optical fibers that carry data between a LIDAR chip and remote electronics. The LIDAR chip is configured to receive a LIDAR input signal that includes LIDAR data. LIDAR data indicates the relative distance and/or radial velocity between the LIDAR chip and a reflecting object located off the LIDAR chip. The LIDAR chip is also configured to provide optical processing of the LIDAR input signal and to output one or more light signals that are received by the communication link and that include the LIDAR data. The communication link carries the one or more light signals to remote electronics for further processing. The further processing can include extraction of the LIDAR data from the one or more light signals.

The LIDAR system is suitable for use in applications such as vehicles because the one or more optical fibers in the communication link can carry digital signals over the needed distances at the required data rates and/or can carry analog signals that provide the equivalent data rates without adding substantial weight to the application.

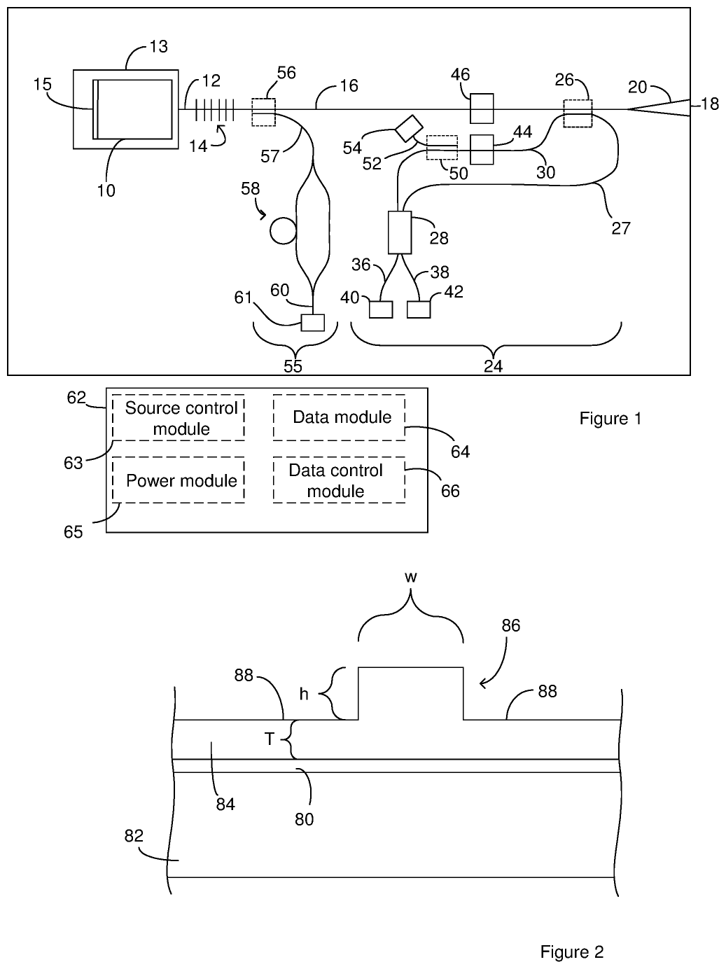

FIG. 1 is a topview of a LIDAR chip that includes a laser cavity. The laser cavity includes a light source 10 that can include or consist of a gain medium (not shown) for a laser. The chip also includes a cavity waveguide 12 that receives a light signal from the light source 10. The light source can be positioned in a recess 13 so a facet of the light source is optically aligned with a facet of the cavity waveguide 12 to allow the light source and cavity waveguide 12 to exchange light signals. The cavity waveguide 12 carries the light signal to a partial return device 14. The illustrated partial return device 14 is an optical grating such as a Bragg grating. However, other partial return devices 14 can be used; for instance, mirrors can be used in conjunction with echelle gratings and arrayed waveguide gratings.

The partial return device 14 returns a return portion of the light signal to the cavity waveguide 12 as a return signal. For instance, the cavity waveguide 12 returns the return signal to the light source 10 such that the return portion of the light signal travels through the gain medium. The light source 10 is configured such that at least a portion of the return signal is added to the light signal that is received at the cavity waveguide 12. For instance, the light source 10 can include a highly, fully, or partially reflective device 15 that reflects the return signal received from the gain medium back into the gain medium. As a result, light can resonate between the partial return device 14 and the reflective device 15 so as to form a Distributed Bragg Reflector (DBR) laser cavity. A DBR laser cavity has an inherently narrow-linewidth and a longer coherence length than DFB lasers and accordingly improves performance when an object reflecting the LIDAR output signal from the chip is located further away from the chip.

The partial return device 14 passes a portion of the light signal received from the cavity waveguide 12 to a utility waveguide 16 included on the chip. The portion of the light signal that the utility waveguide 16 receives from the partial return device 14 serves as the output of the laser cavity. The output of the laser cavity serves as an outgoing LIDAR signal on the utility waveguide 16. The utility waveguide 16 terminates at a facet 18 and carries the outgoing LIDAR signal to the facet 18. The facet 18 can be positioned such that the outgoing LIDAR signal traveling through the facet 18 exits the chip and serves as a LIDAR output signal. For instance, the facet 18 can be positioned at an edge of the chip so the outgoing LIDAR signal traveling through the facet 18 exits the chip and serves as a LIDAR output signal.

The LIDAR output signal travels away from the chip and is reflected by objects in the path of the LIDAR signal. The reflected signal travels away from the objects. At least a portion of the reflected signal returns to the facet 18 of the utility waveguide 16. Accordingly, a portion of the reflected signal can enter the utility waveguide 16 through the facet 18 and serve as a LIDAR input signal guided by the utility waveguide 16.

The utility waveguide 16 can include a tapered portion before the facet 18. For instance, the utility waveguide 16 can include a taper 20 that terminate at the facet 18. The taper 20 can relax the alignment tolerances required for efficient coupling of the utility waveguide 16 to the LIDAR input light and the outgoing LIDAR signal. Accordingly, the taper 20 can increase the percentage of the LIDAR input signal that is successfully returned to the chip for processing. In some instances, the taper 20 is constructed such that the facet 18 has an area that is more than two, five, or ten times the area of a cross section of a straight portion of the utility waveguide 16. Although FIG. 1 shows the taper 20 as a horizontal taper, the taper 20 can be a horizontal and/or vertical taper. The horizontal and/or vertical taper can be linear and/or curved. In some instances, the taper 20 is an adiabatic taper.

The chip includes a data branch 24 where the optical signals that are processed for LIDAR data are generated. The data branch includes an optical coupler 26 that moves a portion of the light signals from the utility waveguide 16 into the data branch. For instance, an optical coupler 26 couples a portion of the outgoing LIDAR signal from the utility waveguide 16 onto a reference waveguide 27 as a reference signal. The reference waveguide 27 carries the reference signal to a first light-combining component 28.

The optical coupler 26 also couples a portion of the LIDAR input signal from the utility waveguide 16 onto a comparative waveguide 30 as a comparative signal. The comparative signal includes at least a portion of the light from the LIDAR input signal. The comparative signal can exclude light from the reference light signal. The comparative waveguide 30 carries the comparative signal to the first light-combining component 28.

The illustrated optical coupler 26 is a result of positioning the utility waveguide 16 sufficiently close to the reference waveguide 27 and the comparative waveguide 30 that light from the utility waveguide 16 is coupled into the reference waveguide 27 and the comparative waveguide 30; however, other signal tapping components can be used to move a portion of the of the light signals from the utility waveguide 16 onto the reference waveguide 27 and the comparative waveguide 30. Examples of suitable signal tapping components include, but are not limited to, y-junctions, multi-mode interference couplers (MMIs), and circulators.

The first light-combining component 28 combines the comparative signal and the reference signal into a first composite signal. The reference signal includes light from the outgoing LIDAR signal. For instance, the reference signal can serve as a sample of the outgoing LIDAR signal. The reference signal can exclude light from the LIDAR output signal and the LIDAR input signal. In contrast, the comparative signal light includes light from the LIDAR input signal. For instance, the comparative signal can serve as a sample of the LIDAR input signal. Accordingly, the comparative signal has been reflected by an object located off the chip while the LIDAR output signal has not been reflected. When the chip and the reflecting object have a non-zero radial velocity, the comparative signal and the reference signal have different frequencies due to the Doppler effect. As a result, beating occurs between the comparative signal and the reference signal.

The first light-combining component 28 also splits the resulting first composite signal onto a first detector waveguide 36 and a second detector waveguide 38. The first detector waveguide 36 carries a first portion of the first composite signal to a first light sensor 40 that converts the first portion of the first composite signal to a first electrical signal. The second detector waveguide 38 carries a second portion of the composite signal to a second light sensor 42 that converts the second portion of the composite signal to a second electrical signal. Examples of suitable light sensors include germanium photodiodes (PDs), and avalanche photodiodes (APDs).

The light combining component 28, the first light sensor 40 and the second light sensor 42 can be connected as a balanced photodetector that outputs an electrical data signal. For instance, the light combining component 28, the first light sensor 40 and the second light sensor 42 can be connected such that the DC components of the signal photocurrents cancel, improving detection sensitivity. Suitable methods for connecting the first light sensor 40 and the second light sensor 42 as balanced photodetectors includes connecting the first light sensor 40 and the second light sensor 42 in series. In one example, the first light sensor 40 and the second light sensor 42 are both avalanche photodiodes connected in series. Balanced photodetection is desirable for detection of small signal fluctuations.

An example of a suitable first light-combining component 28 is a Multi-Mode Interference (MMI) device such as a 2×2 MMI device. Other suitable light-combining components 28 include, but are not limited to, adiabatic splitters, and directional couplers. In some instances, the functions of the illustrated first light-combining component 28 are performed by more than one optical component or a combination of optical components.

A single light sensor can replace the first light sensor 40 and the second light sensor 42 and can output the data signal. When a single light sensor replaces the first light sensor 40 and the second light sensor 42, the first light-combining component 28 need not include light-splitting functionality. As a result, the illustrated light first light-combining component 28 can be a 2×1 light-combining component rather than the illustrated 2×1 light-combining component. For instance, the illustrated light light-combining component can be a 2×1 MMI device. In these instances, the chip includes a single detector waveguide that carries the composite signal to the light sensor.

The data branch includes a data optical attenuator 44 positioned along the comparative waveguide 30 such that the data optical attenuator 44 can be operated so as to attenuate the comparative signal on the comparative waveguide 30. The chip also includes an output optical attenuator 46 positioned along the utility waveguide 16 such that the output optical attenuator 46 can be operated so as to attenuate the outgoing LIDAR signal on the utility waveguide 16. Suitable attenuators for the data optical attenuator 44 and/or the output optical attenuator 46 are configured to attenuate intensity of a light signal. Examples of a suitable attenuator configured to attenuate intensity of a light signal include carrier injection based PIN diodes, electro-absorption modulators, and Mach-Zehnder (MZ) modulators.

The chip also includes a sampling directional coupler 50 that couples a portion of the comparative signal from the comparative waveguide 30 onto a sampling waveguide 52. The coupled portion of the comparative signal serves as a sampling signal. The sampling waveguide 52 carries the sampling signal to a sampling light sensor 54. Although FIG. 1 illustrates a sampling directional coupler 50 moving a portion of the comparative signal onto the sampling waveguide 52, other signal tapping components can be used to move a portion of the comparative signal from the comparative waveguide 30 onto the sampling waveguide 52. Examples of suitable signal tapping components include, but are not limited to, y-junctions, and MMIs.

The chip includes a control branch 55 for controlling operation of the laser cavity. The control branch includes a directional coupler 56 that moves a portion of the outgoing LIDAR signal from the utility waveguide 16 onto a control waveguide 57. The coupled portion of the outgoing LIDAR signal serves as a tapped signal. Although FIG. 1 illustrates a directional coupler 56 moving portion of the outgoing LIDAR signal onto the control waveguide 57, other signal-tapping components can be used to move a portion of the outgoing LIDAR signal from the utility waveguide 16 onto the control waveguide 57. Examples of suitable signal tapping components include, but are not limited to, y-junctions, and MMIs.

The control waveguide 57 carries the tapped signal to an interferometer 58 that splits the tapped signal and then re-combines the different portions of the tapped signal with a phase differential between the portions of the tapped signal. The illustrated interferometer 58 is a Mach-Zehnder interferometer; however, other interferometers can be used.

The interferometer 58 outputs a control light signal on an interferometer waveguide 60. The interferometer waveguide 60 carries the control light signal to a control light sensor 61 that converts the control light signal to an electrical signal that serves as an electrical control signal. The interferometer signal has an intensity that is a function of the frequency of the outgoing LIDAR signal. For instance, a Mach-Zehnder interferometer will output a sinusoidal control light signal with a fringe pattern. Changes to the frequency of the outgoing LIDAR signal will cause changes to the frequency of the control light signal. Accordingly, the frequency of the electrical control signal output from the control light sensor 61 is a function of the frequency of the outgoing LIDAR signal. Other detection mechanisms can be used in place of the control light sensor 61. For instance, the control light sensor 61 can be replaced with a balanced photodetector arranged as the light combining component 28, the first light sensor 40 and the second light sensor 42.

Electronics 62 can operate one or more components on the chip. For instance, the electronics 62 can be in electrical communication with and control operation of the light source 10, the data optical attenuator 44, output optical attenuator 46, the first light sensor 40, the second light sensor 42, the sampling light sensor 54, and the control light sensor 61. Although the electronics 62 are shown off the chip, all or a portion of the electronics can be included on the chip. For instance, the chip can include electrical conductors that connect the first light sensor 40 in series with the second light sensor 42.

The electronics 62 can include a source control module 63. During operation of the chip, the source control module 63 can operate the light source 10 such that the laser cavity outputs the outgoing LIDAR signal. The source control module 63 can operate the light source through a series of cycles where each cycle generates at least a distance data point. During each cycle, the data signal can be sampled one or more times. During each of the samples, the source control module 63 can optionally tune the frequency of the outgoing LIDAR signal. As will be described in more detail below, the source control module 63 can employ output from the control branch in order to control the frequency of the outgoing LIDAR signal such that the frequency of the outgoing LIDAR signal as a function of time is known to the electronics. In some instance, a cycle includes a first sample and a second sample. During the first sample, the source control module 63 can increase the frequency of the outgoing LIDAR signal and during a second sample the source control module 63 can decrease the frequency of the outgoing LIDAR signal. For instance, the laser cavity can be configured to output an outgoing LIDAR signal (and accordingly a LIDAR output signal) with a wavelength of 1550 nm. During the first sample, the source control module 63 can increase the frequency of the outgoing LIDAR signal (and accordingly a LIDAR output signal) such that the wavelength decreases from 1550 nm to 1459.98 nm followed by decreasing the frequency of the outgoing LIDAR signal such that the wavelength increases from 1459.98 nm to 1550 nm.

When the outgoing LIDAR signal frequency is increased during the first sample, the LIDAR output signal travels away from the chip and then returns to the chip as a LIDAR input signal. A portion of the LIDAR input signal becomes the comparative signal. During the time that the LIDAR output signal and the LIDAR input signal are traveling between the chip and a reflecting object, the frequency of the outgoing LIDAR signal continues to increase. Since a portion of the outgoing LIDAR signal becomes the reference signal, the frequency of the reference signal continues to increase. As a result, the comparative signal enters the light-combining component with a lower frequency than the reference signal concurrently entering the light-combining component. Additionally, the further the reflecting object is located from the chip, the more the frequency of the reference signal increases before the LIDAR input signal returns to the chip. Accordingly, the larger the difference between the frequency of the comparative signal and the frequency of the reference signal, the further the reflecting object is from the chip. As a result, the difference between the frequency of the comparative signal and the frequency of the reference signal is a function of the distance between the chip and the reflecting object.

For the same reasons, when the outgoing LIDAR signal frequency is decreased during the second sample, the comparative signal enters the light-combining component with a higher frequency than the reference signal concurrently entering the light-combining component and the difference between the frequency of the comparative signal and the frequency of the reference signal during the second sample is also function of the distance between the chip and the reflecting object.

In some instances, the difference between the frequency of the comparative signal and the frequency of the reference signal can also be a function of the Doppler effect because relative movement of the chip and reflecting object can also affect the frequency of the comparative signal. For instance, when the chip is moving toward or away from the reflecting object and/or the reflecting object is moving toward or away from the chip, the Doppler effect can affect the frequency of the comparative signal. Since the frequency of the comparative signal is a function of the speed the reflecting object is moving toward or away from the chip and/or the speed the chip is moving toward or away from the reflecting object, the difference between the frequency of the comparative signal and the frequency of the reference signal is also a function of the speed the reflecting object is moving toward or away from the chip and/or the speed the chip is moving toward or away from the reflecting object. Accordingly, the difference between the frequency of the comparative signal and the frequency of the reference signal is a function of the distance between the chip and the reflecting object and is also a function of the Doppler effect.

The composite signal and the data signal each effectively compares the comparative signal and the reference signal. For instance, since the light-combining component combines the comparative signal and the reference signal and these signals have different frequencies, there is beating between the comparative signal and reference signal. Accordingly, the composite signal and the data signal have a beat frequency related to the frequency difference between the comparative signal and the reference signal and the beat frequency can be used to determine the difference in the frequency of the comparative signal and the reference signal. A higher beat frequency for the composite signal and/or the data signal indicates a higher differential between the frequencies of the comparative signal and the reference signal. As a result, the beat frequency of the data signal is a function of the distance between the chip and the reflecting object and is also a function of the Doppler effect.

The electronics 62 can include a data processing module 64 that can use the composite signal and the data signal to determine the distance between the chip and the reflecting object and/or the radial velocity between the chip and the reflecting object (i.e., the contribution of the Doppler effect). As noted above, the beat frequency is a function of two unknowns; the distance between the chip and the reflecting object and the radial velocity of the chip and the reflecting object (i.e., the contribution of the Doppler effect). The Doppler frequency difference between the comparative signal and the reference signal (Δf) is given by Δf=2Δvf/c where f is the frequency of the LIDAR output signal and accordingly the reference signal, Δv is the radial velocity of the chip and the reflecting object and c is the speed of light in air. The use of multiple different samples permits the data processing module 64 to resolve the two unknowns. For instance, the beat frequency determined for the first sample is related to the unknown distance and Doppler contribution and the beat frequency determined for the second sample is also related to the unknown distance and Doppler contribution. The availability of the two relationships allows the data processing module 64 to resolve the two unknowns. Accordingly, the distance between the chip and the reflecting object can be determined without influence from the Doppler effect. Further, in some instances, the data processing module 64 uses this distance in combination with the Doppler effect to determine the radial velocity between the reflecting object and the LIDAR chip.

In instances where the radial velocity of target and source is zero or very small, the contribution of the Doppler effect to the beat frequency is essentially zero. In these instances, the Doppler effect does not make a substantial contribution to the beat frequency and the electronics 62 can take only the first sample to determine the distance between the chip and the reflecting object.

During operation, the source control module 63 can adjust the frequency of the outgoing LIDAR signal in response to the electrical control signal output from the control light sensor 61. As noted above, the magnitude of the electrical control signal output from the control light sensor 61 is a function of the frequency of the outgoing LIDAR signal. Accordingly, the source control module 63 can adjust the frequency of the outgoing LIDAR signal in response to the magnitude of the electrical control signal. For instance, while changing the frequency of the outgoing LIDAR signal during one of the samples, the electronics 62 can have a range of suitable values for the electrical control signal magnitude as a function of time. At multiple different times during a sample, the source control module 63 can compare the electrical control signal magnitude to the range of values associated with the current time in the sample. If the electrical control signal magnitude indicates that the frequency of the outgoing LIDAR signal is outside the associated range of electrical control signal magnitudes, the source control module 63 can operate the light source 10 so as to change the frequency of the outgoing LIDAR signal so it falls within the associated range. If the electrical control signal magnitude indicates that the frequency of the outgoing LIDAR signal is within the associated range of electrical control signal magnitudes, the source control module 63 does not change the frequency of the outgoing LIDAR signal.

The electronics 62 can include a power module 65 configured to operate the output optical attenuator 46. During operation, the power module 65 can adjust the level of attenuation provided by the output optical attenuator 46 in response to the sampling signal from the sampling light sensor 54. For instance, the power module 65 can operate the output optical attenuator 46 so as to increase the level of attenuation in response to the magnitude of the sampling signal being above a first signal threshold and/or decrease the magnitude of the power drop in response to the magnitude of the sampling signal being below a second signal threshold.

In some instance, the power module 65 adjusts the level of attenuation provided by the output optical attenuator 46 to prevent or reduce the effects of back-reflection on the performance of the laser cavity. For instance, the first signal threshold and/or the second signal threshold can optionally be selected to prevent or reduce the effects of back-reflection on the performance of the laser cavity. Back reflection occurs when a portion of the LIDAR input signal returns to the laser cavity as a returned LIDAR signal. In some instances, on the order of 50% of the LIDAR input signal that passes through the facet 18 returns to the laser cavity. The returned LIDAR signal can affect performance of the laser cavity when the power of the returned LIDAR signal entering the partial return device 14 does not decrease below the power of the outgoing LIDAR signal exiting from the partial return device 14 (“power drop”) by more than a minimum power drop threshold. In the illustrated chip, the minimum power drop threshold can be around 35 dB (0.03%). Accordingly, the returned LIDAR signal can affect the performance of the laser cavity when the power of the returned LIDAR signal entering the partial return device 14 is not more than 35 dB below the power of the outgoing LIDAR signal exiting from the partial return device 14.

The power module 65 can operate the output optical attenuator 46 so as to reduce the effect of low power drops, e.g. when the target object is very close or highly reflective or both. As is evident from FIG. 1, operation of the output optical attenuator 46 so as to increase the level of attenuation reduces the power of the returned LIDAR signal entering the partial return device 14 and also reduces the power of the returned outgoing LIDAR signal at a location away from the partial return device 14. Since the output optical attenuator 46 is located apart from the partial return device 14, the power of the outgoing LIDAR signal exiting from the partial return device 14 is not directly affected by the operation of the output optical attenuator 46. Accordingly, the operation of the output optical attenuator 46 so as to increase the level of attenuation increases the level of the power drop. As a result, the electronics can employ the optical attenuator 46 so as to tune the power drop.

Additionally, the magnitude of the sampling signal is related to the power drop. For instance, the magnitude of the sampling signal is related to the power of the comparative signal as is evident from FIG. 1. Since the comparative signal is a portion of the LIDAR input signal, the magnitude of the sampling signal is related to the power of the LIDAR input signal. This result means the magnitude of the sampling signal is also related to the power of the returned LIDAR signal because the returned LIDAR signal is a portion of the LIDAR input signal. Accordingly, the magnitude of the sampling signal is related to the power drop.

Since the magnitude of the sampling signal is related to the power drop, the power module 65 can use the magnitude of the sampling signal to operate the output optical attenuator so as to keep the magnitude of the comparative signal power within a target range. For instance, the power module 65 can operate the output optical attenuator 46 so as to increase the magnitude of the power drop in response to the sampling signal indicating that the magnitude of power drop is at or below a first threshold and/or the electronics 62 can operate the output optical attenuator 46 so as to decrease the magnitude of the power drop in response to the sampling signal indicating that the magnitude of power drop is at or above a second threshold. In some instances, the first threshold is greater than or equal to the minimum power drop threshold. In one example, the power module 65 operates the output optical attenuator 46 so as to increase the magnitude of the power drop in response to the magnitude of the sampling signal being above a first signal threshold and/or decrease the magnitude of the power drop in response to the magnitude of the sampling signal being below a second signal threshold. The identification of the value(s) for one, two, three, or four variables selected from the group consisting of the first threshold, the second threshold, the first signal threshold, and the second signal threshold can be determined from calibration of the optical chip during set-up of the LIDAR chip system.

The electronics 62 can include a data control module 66 configured to operate the data optical attenuator 44. Light sensors can become saturated when the power of the composite light signal exceeds a power threshold. When a light sensor becomes saturated, the magnitude of the data signal hits a maximum value that does not increase despite additional increases in the power of the composite light signal above the power threshold. Accordingly, data can be lost when the power of the composite light signal exceeds a power threshold. During operation, the data control module 66 can adjust the level of attenuation provided by the data optical attenuator 44 so the power of the composite light signal is maintained below a power threshold.

As is evident from FIG. 1, the magnitude of the sampling signal is related to the power of the comparative signal. Accordingly, the data control module 66 can operate the data optical attenuator 44 in response to output from the sampling signal. For instance, the data control module 66 can operate the data optical attenuator so as to increase attenuation of the comparative signal when the magnitude of the sampling signal indicates the power of the comparative signal is above an upper comparative signal threshold and/or can operate the data optical attenuator so as to decrease attenuation of the comparative signal when the magnitude of the sampling signal indicates the power of the comparative signal is below a lower comparative signal threshold. For instance, in some instances, the data control module 66 can increase attenuation of the comparative signal when the magnitude of the sampling signal is at or above an upper comparative threshold and/or the data control module 66 decrease attenuation of the comparative signal when the magnitude of the sampling signal is at or below an upper comparative signal threshold.

As noted above, the electronics 62 can adjust the level of attenuation provided by the output optical attenuator 46 in response to the sampling signal. The electronics 62 can adjust the level of attenuation provided by the data optical attenuator 44 in response to the sampling signal in addition or as an alternative to adjusting the level of attenuation provided by the output optical attenuator 46 in response to the sampling signal.

Suitable platforms for the chip include, but are not limited to, silica, indium phosphide, and silicon-on-insulator wafers. FIG. 2 is a cross-section of portion of a chip constructed from a silicon-on-insulator wafer. A silicon-on-insulator (SOI) wafer includes a buried layer 80 between a substrate 82 and a light-transmitting medium 84. In a silicon-on-insulator wafer, the buried layer is silica while the substrate and the light-transmitting medium are silicon. The substrate of an optical platform such as an SOI wafer can serve as the base for the entire chip. For instance, the optical components shown in FIG. 1 can be positioned on or over the top and/or lateral sides of the substrate.

The portion of the chip illustrated in FIG. 2 includes a waveguide construction that is suitable for use with chips constructed from silicon-on-insulator wafers. A ridge 86 of the light-transmitting medium extends away from slab regions 88 of the light-transmitting medium. The light signals are constrained between the top of the ridge and the buried oxide layer.

The dimensions of the ridge waveguide are labeled in FIG. 2. For instance, the ridge has a width labeled w and a height labeled h. A thickness of the slab regions is labeled T. For LIDAR applications, these dimensions are more important than other applications because of the need to use higher levels of optical power than are used in other applications. The ridge width (labeled w) is greater than 1 μm and less than 4 μm, the ridge height (labeled h) is greater than 1 μm and less than 4 μm, the slab region thickness is greater than 0.5 μm and less than 3 μm. These dimensions can apply to straight or substantially straight portions of the waveguide, curved portions of the waveguide and tapered portions of the waveguide(s). Accordingly, these portions of the waveguide will be single mode. However, in some instances, these dimensions apply to straight or substantially straight portions of a waveguide while curved portions of the waveguide and/or tapered portions of the waveguide have dimensions outside of these ranges. For instance, the tapered portions of the utility waveguide 16 illustrated in FIG. 1 can have a width and/or height that is >4 μm and can be in a range of 4 μm to 12 μm. Additionally or alternately, curved portions of a waveguide can have a reduced slab thickness in order to reduce optical loss in the curved portions of the waveguide. For instance, a curved portion of a waveguide can have a ridge that extends away from a slab region with a thickness greater than or equal to 0.0 μm and less than 0.5 μm. While the above dimensions will generally provide the straight or substantially straight portions of a waveguide with a single-mode construction, they can result in the tapered section(s) and/or curved section(s) that are multimode. Coupling between the multi-mode geometry to the single mode geometry can be done using tapers that do not substantially excite the higher order modes. Accordingly, the waveguides can be constructed such that the signals carried in the waveguides are carried in a single mode even when carried in waveguide sections having multi-mode dimensions. The waveguide construction of FIG. 2 is suitable for all or a portion of the waveguides selected from the group consisting of the cavity waveguide 12, utility waveguide 16, reference waveguide 27, comparative waveguide 30, first detector waveguide 36, second detector waveguide 38, sampling waveguide 52, control waveguide 57, and interferometer waveguide 60.

The light source 10 that is interfaced with the utility waveguide 16 can be a gain element that is a component separate from the chip and then attached to the chip. For instance, the light source 10 can be a gain element that is attached to the chip using a flip-chip arrangement.

Use of flip-chip arrangements is suitable when the light source 10 is to be interfaced with a ridge waveguide on a chip constructed from silicon-on-insulator wafer. Examples of suitable interfaces between flip-chip gain elements and ridge waveguides on chips constructed from silicon-on-insulator wafer can be found in U.S. Pat. No. 9,705,278, issued on Jul. 11, 2017 and in U.S. Pat. No. 5,991,484 issued on Nov. 23, 1999; each of which is incorporated herein in its entirety. The constructions are suitable for use as the light source 10. When the light source 10 is a gain element, the electronics 62 can change the frequency of the outgoing LIDAR signal by changing the level of electrical current applied to through the gain element.

The attenuators can be a component that is separate from the chip and then attached to the chip. For instance, the attenuator can be included on an attenuator chip that is attached to the chip in a flip-chip arrangement. The use of attenuator chips is suitable for all or a portion of the attenuators selected from the group consisting of the data attenuator and the control attenuator.

As an alternative to including an attenuator on a separate component, all or a portion of the attenuators can be integrated with the chip. For instance, examples of attenuators that are interfaced with ridge waveguides on a chip constructed from a silicon-on-insulator wafer can be found in U.S. Pat. No. 5,908,305, issued on Jun. 1, 1999; each of which is incorporated herein in its entirety. The use of attenuators that are integrated with the chip are suitable for all or a portion of the light sensors selected from the group consisting of the data attenuator and the control attenuator.

Light sensors that are interfaced with waveguides on a chip can be a component that is separate from the chip and then attached to the chip. For instance, the light sensor can be a photodiode, or an avalanche photodiode. Examples of suitable light sensor components include, but are not limited to, InGaAs PIN photodiodes manufactured by Hamamatsu located in Hamamatsu City, Japan, or an InGaAs APD (Avalanche Photo Diode) manufactured by Hamamatsu located in Hamamatsu City, Japan. These light sensors can be centrally located on the chip as illustrated in FIG. 1. Alternately, all or a portion the waveguides that terminate at a light sensor can terminate at a facet 18 located at an edge of the chip and the light sensor can be attached to the edge of the chip over the facet 18 such that the light sensor receives light that passes through the facet 18. The use of light sensors that are a separate component from the chip is suitable for all or a portion of the light sensors selected from the group consisting of the first light sensor 40, the second light sensor 42, the sampling light sensor 54, and the control light sensor 61.

As an alternative to a light sensor that is a separate component, all or a portion of the light sensors can be integrated with the chip. For instance, examples of light sensors that are interfaced with ridge waveguides on a chip constructed from a silicon-on-insulator wafer can be found in Optics Express Vol. 15, No. 21, 13965-13971 (2007); U.S. Pat. No. 8,093,080, issued on Jan. 10, 2012; U.S. Pat. No. 8,242,432, issued Aug. 14, 2012; and U.S. Pat. No. 6,108,8472, issued on Aug. 22, 2000 each of which is incorporated herein in its entirety. The use of light sensors that are integrated with the chip are suitable for all or a portion of the light sensors selected from the group consisting of the first light sensor 40, the second light sensor 42, the sampling light sensor 54, and the control light sensor 61.

Construction of optical gratings that are integrated with a variety of optical device platforms are available. For instance, a Bragg grating can be formed in a ridge waveguides by forming grooves in the top of the ridge and/or in the later sides of the ridge.

In some instances, it is desirable to scan the LIDAR output signal. For instance, many LIDAR specifications require that LIDAR data be generated for multiple different regions in a field of view. These LIDAR specifications can be satisfied by scanning the LIDAR output signal to a series of the regions and generating the LIDAR at each region. Accordingly, each cycle and the resulting LIDAR data can be associated with a different region in the field of view.

The above LIDAR chips are suitable for use with various scanning mechanisms. For instance, the output LIDAR signal can be received by one or more reflecting devices and/or one more collimating devices. The one or more reflecting devices can be configured to re-direct and/or steer the LIDAR output signal so as to provide scanning of the LIDAR output signal. Suitable reflecting devices include, but are not limited to, mirrors such mechanically driven mirrors and Micro Electro Mechanical System (MEMS) mirrors. The one or more collimating devices provide collimation of the LIDAR output signal and can accordingly increase the portion of the LIDAR input signal that is received in the utility waveguide 16. Suitable collimating devices include, but are not limited to, individual lenses and compound lenses.

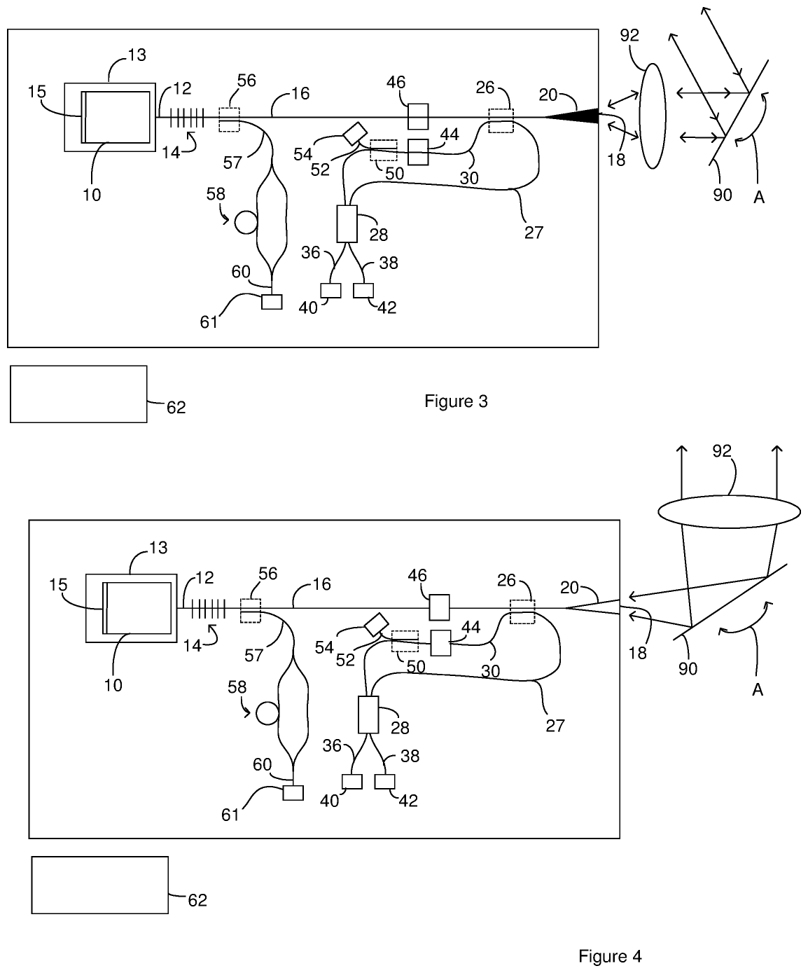

FIG. 3 illustrates the above chip used with a reflecting device 90 and a collimating device 92. For instance, a lens serves as a collimating device that receives the LIDAR output signal and provides collimation of the LIDAR output signal. A mirror serves as a reflecting device 90 that receives the collimated LIDAR output signal and reflects the collimated LIDAR output signal in the desired direction. As is illustrated by the arrow labeled A, the electronics can move the mirror so as to steer the collimated LIDAR output signal and/or scan the collimated LIDAR output signal. The movement of the mirror can be in two dimensions or three dimensions. Suitable mirrors include, but are not limited to, mechanically driven mirrors and Micro Electro Mechanical System (MEMS) mirrors.

FIG. 4 illustrates the above chip used with a reflecting device 90 and a collimating device 92. For instance, a mirror serves as a reflecting device 90 that receives the LIDAR output signal and reflects the LIDAR output signal in the desired direction. As is illustrated by the arrow labeled A, the electronics can move the mirror so as to steer the LIDAR output signal and/or scan the LIDAR output signal. A lens serves as a collimating device 92 that receives the LIDAR output signal from the mirror and provides collimation of the LIDAR output signal. The lens can be configured to move with the movement of the mirror so the lens continues to receive the LIDAR output signal at different positions of the mirror. Alternately, the movement of the mirror can be sufficiently limited that the lens continues to receive the LIDAR output signal at different positions of the mirror. The movement of the mirror can be in two dimensions or three dimensions. Suitable mirrors include, but are not limited to, mechanically driven mirrors and Micro Electro Mechanical System (MEMS) mirrors.

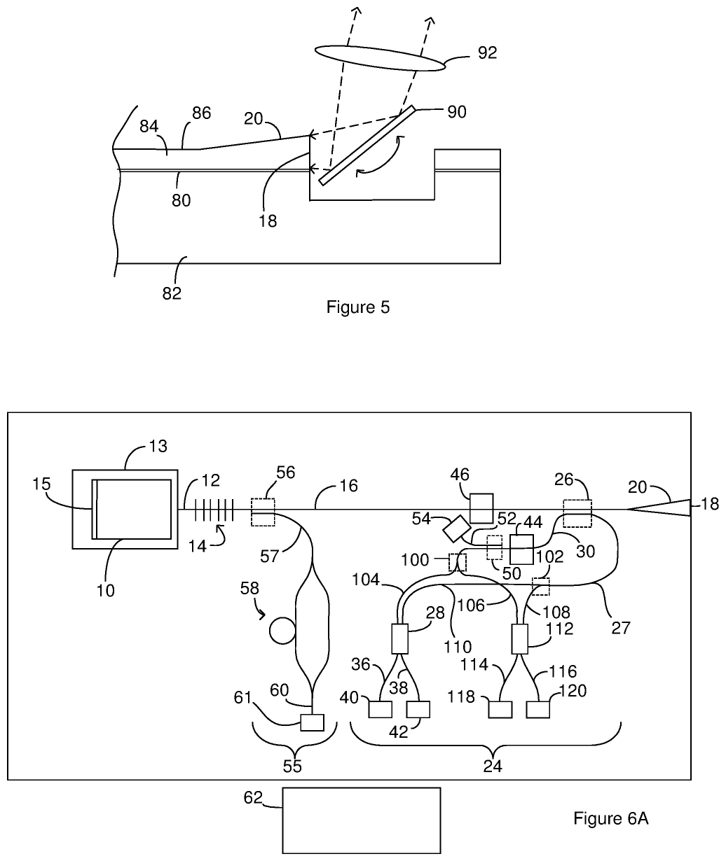

Technologies such as SOI MEMS (Silicon-On-Insulator Micro Electro Mechanical System) technology can be used to incorporate a reflecting device such as a MEMS mirror into the chip. For instance, FIG. 5 is a cross section of a portion of the chip taken through the longitudinal axis of the utility waveguide 16. The illustrated chip was constructed on silicon-on-insulator waveguide. A mirror recess extends through the light-transmitting medium to the base. The mirror is positioned in the mirror recess such that the mirror receives the LIDAR output signal from the utility waveguide. A lens serves as a collimating device 92 that receives the LIDAR output signal from the mirror and provides collimation of the LIDAR output signal. The lens can be configured to move with the movement of the mirror so the lens continues to receive the LIDAR output signal at different positions of the mirror. Alternately, the movement of the mirror can be sufficiently limited that the lens continues to receive the LIDAR output signal at different positions of the mirror. The electronics can control movement of the mirror in two or three dimensions.

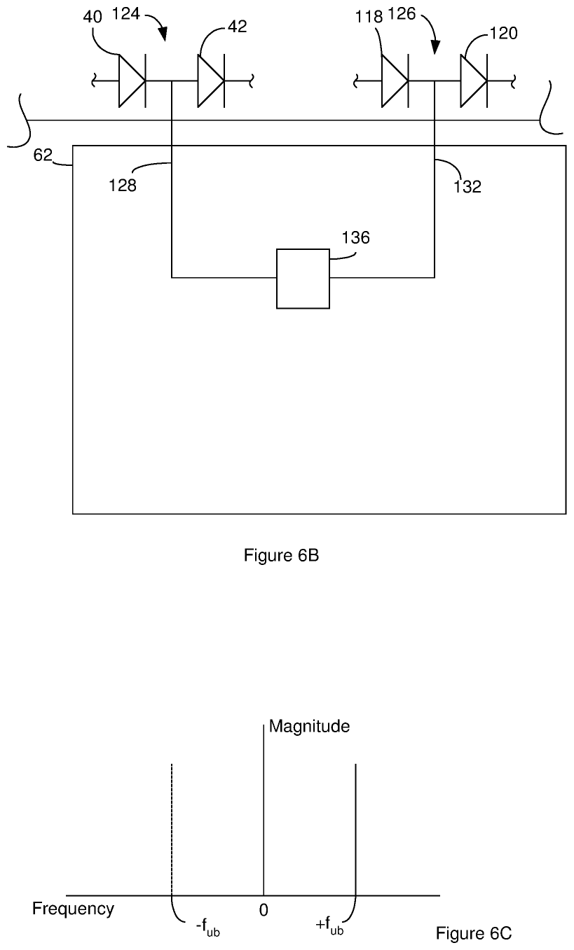

The above chips can be modified so that data branch includes one or more secondary branches and one or more secondary balanced detectors that can be employed to refine the optical data provided to the electronics. The reference signal and the comparative signal can be divided among the different balanced detectors. For instance, FIG. 6A illustrates the above chip modified to include two different balanced detectors.

A first splitter 102 divides the reference signal carried on the reference waveguide 27 onto a first reference waveguide 110 and a second reference waveguide 108. The first reference waveguide 110 carries a first portion of the reference signal to the first light-combining component 28. The second reference waveguide 108 carries a second portion of the reference signal to a second light-combining component 112.

A second splitter 100 divides the comparative signal carried on the comparative waveguide 30 onto a first comparative waveguide 104 and a second comparative waveguide 106. The first comparative waveguide 104 carries a first portion of the comparative signal to the first light-combining component 28. The second comparative waveguide 108 carries a second portion of the comparative signal to the second light-combining component 112.

The first light-combining component 28 combines the first portion of the comparative signal and the first portion of reference signal into the first composite signal. The first light-combining component 28 also splits the first composite signal onto a first detector waveguide 36 and a second detector waveguide 38. The second light-combining component 112 combines the second portion of the comparative signal and the second portion of the reference signal into a second composite signal. The light-combining component 112 also splits the second composite signal onto a first auxiliary detector waveguide 114 and a second auxiliary detector waveguide 116.

The first auxiliary detector waveguide 114 carries a first portion of the second composite signal to a first auxiliary light sensor 118 that converts the first portion of the second composite signal to a first auxiliary electrical signal. The second auxiliary detector waveguide 116 carries a second portion of the second composite signal to a second auxiliary light sensor 120 that converts the second portion of the second composite signal to a second auxiliary electrical signal. Examples of suitable light sensors include germanium photodiodes (PDs), and avalanche photodiodes (APDs).

The first reference waveguide 110 and the second reference waveguide 108 are constructed to provide a phase shift between the first portion of the reference signal and the second portion of the reference signal. For instance, the first reference waveguide 110 and the second reference waveguide 108 can be constructed so as to provide a 90 degree phase shift between the first portion of the reference signal and the second portion of the reference signal. Accordingly, one of the reference signal portions can be a sinusoidal function and the other reference signal portion can be a cosine function. In one example, the first reference waveguide 110 and the second reference waveguide 108 are constructed such that the first reference signal portion is a cosine function and the second reference signal portion is a sinusoidal function. Accordingly, the portion of the reference signal in the first composite signal is phase shifted relative to the portion of the reference signal in the second composite signal, however, the portion of the comparative signal in the first composite signal is not phase shifted relative to the portion of the comparative signal in the second composite signal.

The first light sensor 40 and the second light sensor 42 can be connected as a balanced detector and the first auxiliary light sensor 118 and the second auxiliary light sensor 120 can also be connected as a balanced detector. For instance, FIG. 6B provides a schematic of the relationship between the data module 64 of the electronics 62, the first light sensor 40, the second light sensor 42, the first auxiliary light sensor 118, and the second auxiliary light sensor 120. The symbol for a photodiode is used to represent the first light sensor 40, the second light sensor 42, the first auxiliary light sensor 118, and the second auxiliary light sensor 120 but one or more of these sensors can have other constructions.

The electronics connect the first light sensor 40 and the second light sensor 42 as a first balanced detector 124 and the first auxiliary light sensor 118 and the second auxiliary light sensor 120 as a second balanced detector 126. In particular, the first light sensor 40 and the second light sensor 42 are connected in series. Additionally, the first auxiliary light sensor 118 and the second auxiliary light sensor 120 are connected in series. The serial connection in the first balanced detector is in communication with a first data line 128 that carries the output from the first balanced detector as a first data signal. The serial connection in the second balanced detector is in communication with a second data line 132 that carries the output from the first balanced detector as a second data signal.

The first data line 128 carries the first data signal to a transform module 136 and the second data line 132 carries the second data signal to the transform module 136. The transform module is configured to perform a complex transform on a complex signal so as to convert the input from the time domain to the frequency domain. The first data signal can be the real component of the complex signal and the second data signal can be the imaginary component of the complex. The transform module can execute the attributed functions using firmware, hardware and software or a combination thereof.

The solid line in FIG. 6C provides an example of the output of the transform module when a Complex Fourier transform converts the input from the time domain to the frequency domain. The solid line shows a single frequency peak. The frequency associated with this peak is used by the data module as the frequency of the LIDAR input signal.

The data module uses this frequency for further processing to determine the relative distance and/or radial velocity between the reflecting object and the LIDAR chip. FIG. 6C also includes a second peak illustrated by a dashed line. Prior methods of resolving the frequency of the LIDAR input signal made use of real Fourier transforms rather than the Complex Fourier transform technique disclosed above. These prior methods output both the peak shown by the dashed line and the solid line. As noted above, when using LIDAR applications, it can become difficult to identify the correct peak. Since the above technique for resolving the frequency generates a single solution for the frequency, the inventors have resolved the ambiguity with the frequency solution.

The data module uses the single frequency that would be present in FIG. 6C to determine the distance of the reflecting object from the chip and/or the relative speed of the object and the chip. For instance, the following equation applies during a sample where electronics increase the frequency of the outgoing LIDAR signal: =f_{ub}=f_{d}+ατ_{D} where f_{ub} is the frequency provided by the transform module, f_{d} represents the Doppler shift (f_{d}=2vf_{o/c}) where f_{c} is the frequency of the LIDAR output signal, v is the velocity of the reflecting object relative to the chip where the direction from the reflecting object toward the chip is assumed to be the positive direction, and c is the speed of light, α is the rate of change in the frequency of the outgoing LIDAR signal during the sample period, and τ_{D} is the roundtrip delay for a stationary reflecting object. The following equation applies during a sample where electronics decrease the frequency of the outgoing LIDAR signal: −f_{db}=−f_{d}−ατ₀ where f_{db} is the frequency provided by the transform module. In these two equations, v and τ_{D} are unknowns. The electronics solve these two equations for the two unknowns.

Suitable electronics can include, but are not limited to, a controller that includes or consists of analog electrical circuits, digital electrical circuits, processors, microprocessors, digital signal processors (DSPs), computers, microcomputers, or combinations suitable for performing the operation, monitoring and control functions described above. In some instances, the controller has access to a memory that includes instructions to be executed by the controller during performance of the operation, control and monitoring functions. Although the electronics are illustrated as a single component in a single location, the electronics can include multiple different components that are independent of one another and/or placed in different locations. Additionally, as noted above, all or a portion of the disclosed electronics can be included on the chip including electronics that are integrated with the chip.

A single light sensor can replace the second balanced detector first light sensor 40 and the second light sensor 42 and/or a second light sensor can replace the first auxiliary light sensor 118 and the second auxiliary light sensor 120. When a single light sensor replaces the first light sensor 40 and the second light sensor 42, the first light-combining component 28 need not include light-splitting functionality. As a result, the illustrated light first light-combining component 28 can be a 2×1 light-combining component rather than the illustrated 2×1 light-combining component. For instance, the illustrated light light-combining component can be a 2×1 MMI device. In these instances, the chip includes a single detector waveguide that carries the composite signal to the light sensor.

When a single light sensor replaces the first auxiliary light sensor 118 and the second auxiliary light sensor 120, second light-combining component 112 need not include light-splitting functionality. As a result, the illustrated second light-combining component 112 can be a 2×1 light-combining component rather than the illustrated 2×2 light-combining component. For instance, the illustrated light light-combining component can be a 2×1 MMI device. In these instances, the chip includes a single detector waveguide that carries the composite signal from the second light-combining component 112 to the light sensor.

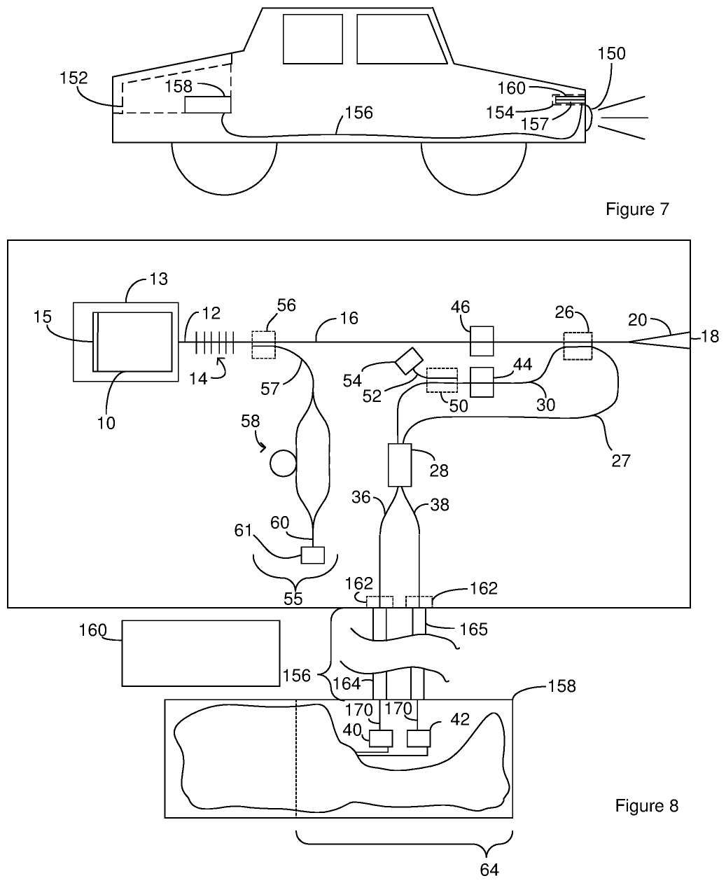

A vehicle can include one or more of the LIDAR chips. For instance, a car that has an ADAS (Advanced Driver Assistance System) and/or a self-driving vehicle can have an optical sensor system with a LIDAR module that includes, consists of, or consists essentially of one or more of the LIDAR chips. As an example, FIG. 7 is a diagram of a vehicle that includes a headlight 150 and a trunk 152. The car includes a LIDAR module 154 located near the headlight 150. For instance, the LIDAR module 154 can be located above, below, and/or beside the headlight 150. Although FIG. 7 illustrates the car having a single LIDAR module, the car can include multiple LIDAR modules. Each of the modules can include or consist of one or more LIDAR chips.

The car also includes a storage region that is remote from the LIDAR module 154 such as a compartment that is accessible from the trunk of a car. A communications link 156 provides communication between one or more LIDAR chips 157 included in the LIDAR module 154 and central electronics 158 located in the storage region. The storage region is generally selected to protect the central electronics 158 from the environment and, in some instances, to provide thermal control of the central electronics 158. In addition to processing signals from one or more LIDAR modules, the central electronics 158 generally processes the signals from a variety of different sensors in the vehicle. For instance, the central electronics 158 can process signals from cameras, inertial sensors, rotational sensors, radar, infra-red (IR) cameras, radionavigation systems such as the Global Positioning System (GPS), and acoustic sensors such as microphones.

Due to the configuration of many vehicles, a communications link that is several meters long is often needed to make the circuitous route from a LIDAR module to the central electronics. In many instances, the communication link needs to provide a digital data rate of more than 0.1 Gbps, more than 10 Gbps or even more than 20 Gbps for a length greater than 5 m, 10 m, or even 20 m as can occur in vehicles such a large trucks. When the communications link carries analog signals, the signals carry the same data at the same rate. Accordingly, the analog signals are carried at equivalent data rates over these distances. Copper wires are often ineffective for carrying data under these conditions. Additionally, copper wires and cables the can carry data at these rates over these distances add greater weight to an autonomous vehicle and also generate more electromagnetic interference (EM) and are more susceptible to EMI from other data signals. This is important for all autonomous vehicles, but will be especially important for airborne autonomous vehicles. A communication link that includes or consists of one or more optical fibers can provide the needed data rates at lengths longer than 5 m, 10 m, or 20 m. Additionally or alternately, a communication link that includes or consists of an optical fiber can be less than 100 m, 200 m, or 500 m.

The electronics 62 disclosed in the context of FIG. 1 through FIG. 6C can be divided between the central electronics 158 and local electronics 160. All or a portion of the local electronics can be in the proximity of the LIDAR module 154. In some instances, all or a portion of the local electronics are included on one or more LIDAR chips in the LIDAR module 154. In some instances, all or a portion of the local electronics 160 are included on one or more LIDAR chips in the LIDAR module 154. In some instances, all or a portion of the local electronics 160 are included inside of packaging for the LIDAR module 154. In some instances, all or a portion of the local electronics 160 are immobilized on packaging for the LIDAR module 154. Accordingly, the distance between the local electronics 160 and the LIDAR module 154 is less than the distance between the central electronics 158 and the LIDAR module 154.

As noted above, the electronics 62 can include one or more modules selected from a group consisting of a source control module 63, a data module 64, a power module 65, and a data control module 66. In some instances, the local electronics 160 includes one, two, or three modules selected from the group consisting of the source control module 63, data module 64, power module 65, and data control module 66 and the central electronics 158 includes one two or three modules selected from the group consisting of the source control module 63, data module 64, power module 65, and data control module 66.

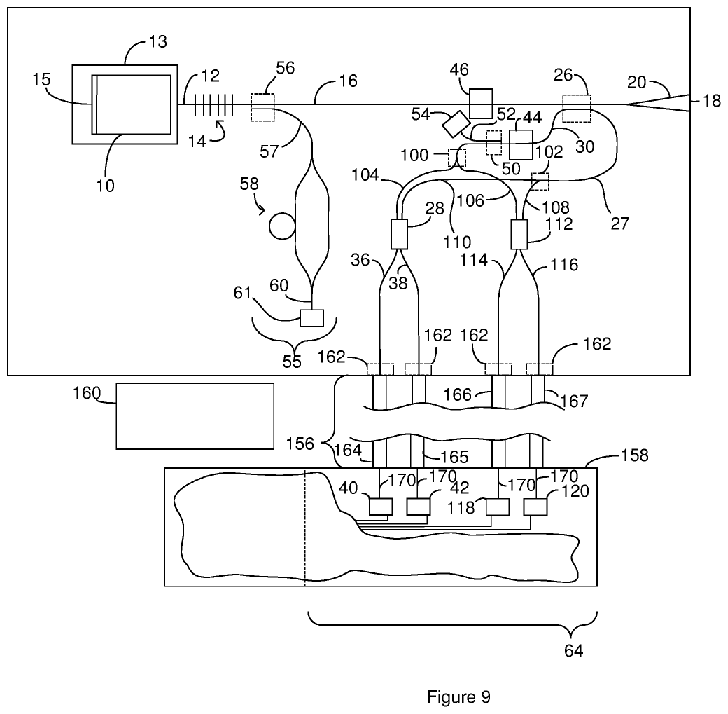

The central electronics 158 can include a portion of the optical and/or electrical components from the LIDAR chips illustrated above. In one example, the local electronics 160 include the source control module 63, data module 64, power module 65, and data control module 66 and the central electronics 158 include the data module 64. When the central electronics 158 include the data module 64, the central electronics 158 can include the first light sensor 40 and the second light sensor 42 of the LIDAR chips disclosed in the context of FIG. 1 through FIG. 6C. Accordingly, the central electronics 158 can include a balanced photodetector that includes the first light sensor 40 and the second light sensor 42 as illustrated in FIG. 8. In some instances, the central electronics 158 can include the first auxiliary light sensor 118 and second auxiliary light sensor 120 in addition to the first light sensor 40 and the second light sensor 42 as disclosed in the context of FIG. 6A through FIG. 6B. Accordingly, the central electronics 158 can include a balanced photodetector that includes the first light sensor 40 and the second light sensor 42 and a second balanced photodetector that includes the first auxiliary light sensor 118 and the second auxiliary light sensor 120 as illustrated in FIG. 9.

When the central electronics 158 include one or more light sensors selected from the group consisting of the first light sensor 40, the second light sensor 42, the first auxiliary light sensor 118 and the second auxiliary light sensor 120, the communications link 156 can include one or more optical fibers. For instance, FIG. 8 shows the communications link 156 having a first optical fiber 164 that guides the first portion of the composite signal to the central electronics 158 and a second optical fiber 165 that guides the second portion of the composite signal to the central electronics 158. The central electronics 158 include a waveguide 170 that guides the first portion of the composite signal to the first light sensor 40 and a waveguide 170 that guides the second portion of the composite signal to the second light sensor 42. The waveguides 170 are optional because the first light sensor 40 and the second light sensor 42 can receive the first portion of the composite signal and the second portion of the composite signal directly from the communication link.

FIG. 9 shows the LIDAR chip of FIG. 6A modified to be used with a communications link 156 that includes a first optical fiber 164 that guides the first portion of the composite signal to the central electronics 158 and a second optical fiber 165 that guides the second portion of the composite signal to the central electronics 158, a third optical fiber 166 that guides the first portion of the second composite signal to the central electronics 158 and a fourth optical fiber 167 that guides the second portion of the second composite signal to the central electronics 158. The central electronics 158 include a waveguide 170 that guides the first portion of the composite signal to the first light sensor 40, a waveguide 170 that guides the second portion of the composite signal to the second light sensor 42, a waveguide 170 that guides the first portion of the second composite signal to the first auxiliary light sensor 118, and a waveguide 170 that guides the second portion of the second composite signal to the second auxiliary light sensor 120. The waveguides 170 are optional because the light sensors can receive the light signals directly from the communication link.

When the optical link 156 includes one or more optical fibers, the LIDAR chip can include an optical port 162 for providing optical communication between a waveguide on the LIDAR chip and the optical fiber. An optical signal can exit from the LIDAR chip through an optical port 162. For instance, a suitable optical port 162 includes the waveguide ending at a facet such as a polished facet through which an optical signal exits from the LIDAR chip. For instance, one or more waveguide selected from a group consisting of a first detector waveguide 36, a second detector waveguide 38, a first auxiliary detector waveguide 114 and a second auxiliary detector waveguide 116 can terminate at a facet that is optically aligned with a facet of an optical fiber. An optical port 162 can be constructed such that a light signal output from the port 162 exits the LIDAR chip above the LIDAR chip, below the LIDAR chip, or from an edge of the LIDAR. Although the optical port 162 is disclosed in the context of optical signals exiting from the LIDAR chip, the LIDAR chip can additionally or alternately be operated such that light signals enter the LIDAR chip through an optical port 162. Suitable constructions of optical ports that providing optical communication between a waveguide and an optical fiber include, but are not limited to, U.S. Pat. No. 6,108,472, filed on Feb. 6, 1998, given Ser. No. 09/019,729, entitled “Device for Re-directing Light From Optical Waveguide,” and incorporated herein in its entirety and in U.S. Pat. No. 7,245,803, filed on Feb. 10, 2004, given Ser. No. 10/776,475, entitled “Optical Waveguide Grating Coupler,” and incorporated herein in its entirety. In some instances, the LIDAR system can include one or more optical components between a facet on the LIDAR chip and a facet of the optical fiber for one or more pairs of LIDAR chip facets and fiber facets that are exchanging light signals. For instance, the LIDAR system can include a lens and/or other optical component between a facet on the LIDAR chip and a facet of the optical fiber with which the facet exchanges light signals.

In the LIDAR chip of FIG. 8 and FIG. 9, one or more light signals selected from the group consisting of the first portion of the composite signal, the second portion of the composite signal, the first portion of the second composite signal, and second portion of the second composite signal exit the LIDAR chip through an optical port. Each of these light signals includes light from the reflected signal. Accordingly, the light signal(s) that exit the LIDAR chip through an optical port 162 can include light from the reflected signal. The first portion of the composite signal, the second portion of the composite signal, the first portion of the second composite signal, and the second portion of the second composite signal also include light from the reference signal. Accordingly, the light signal(s) that exit the LIDAR chip through an optical port 162 can additionally or alternately include light from a reference signal and/or light that is not reflected by an object. The light signal(s) that exit the LIDAR chip through an optical port 162 can be digital or analog. However, the first portion of the composite signal, the second portion of the composite signal, the first portion of the second composite signal, and second portion of the second composite signal have not undergone digital processing and are accordingly analog signals. As a result, the light signal(s) that exit the LIDAR chip through an optical port 162 can be analog signals that undergo digital processing off the chip and/or at the central electronics 158.

Although the optical port 162 is disclosed in the context of providing optical signals for a data module included in the central electronics, a LIDAR chip can include one or more optical ports for other applications. For instance, a LIDAR chip can include an optical port 162 that transmits optical signals for a source control module 63, power module 65, and/or data control module 66.

FIG. 8 and FIG. 9 illustrate the optical components from the LIDAR chip of FIG. 1 and FIG. 3 distributed between the LIDAR chip and the central electronics. As an example, in FIG. 8, the central electronics includes the first light sensor 40 and the second light sensor 42 from the LIDAR chip illustrated in FIG. 1. However other distributions of the optical components between the LIDAR chip and the central electronics can be employed. As an example, the remote electronics can include the first light-combining component 28, the first detector waveguide 36, the second detector waveguide 38, the first light sensor 40, and the second light sensor 42 from the LIDAR chip illustrated in FIG. 1 and the remote electronics can have these optical components configured to operate as disclosed in the context of FIG. 1. In such an embodiment, the LIDAR chip can include an optical port through which the reference signal exits from the LIDAR chip and is received by the communication link. The LIDAR chip can include an optical port through which the comparative signal exits from the LIDAR chip. The communication link can then carry these light signals to the optical components on the remote electronics which can then process these light signals as disclosed in the context of FIG. 1.

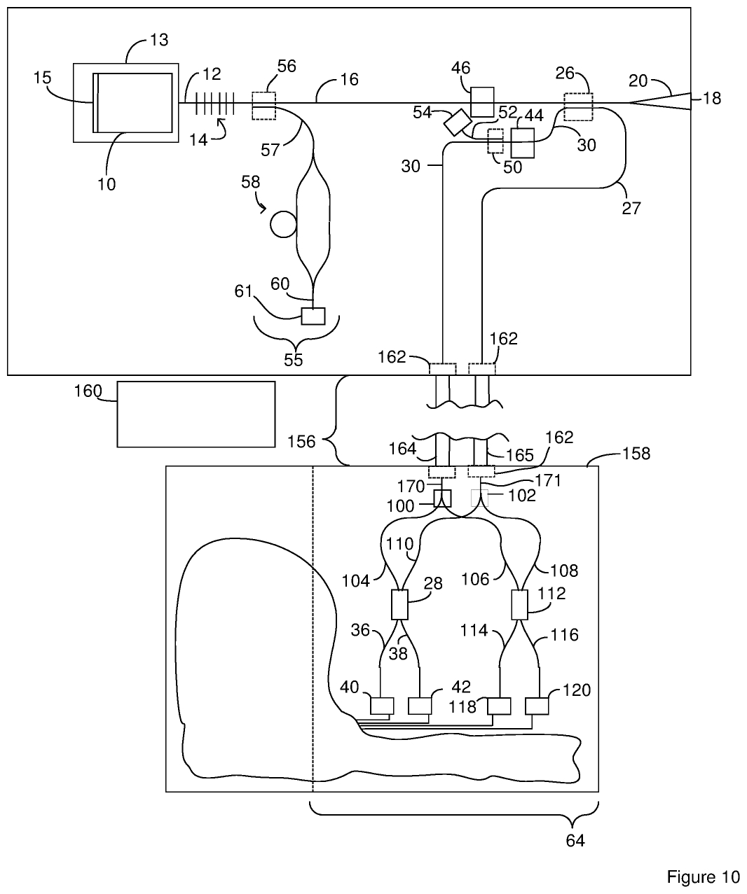

FIG. 10 provides another possible distribution of the optical components from the LIDAR chip between the LIDAR chip and the central electronics. The central electronics include the first splitter 102, the second splitter 100, the first comparative waveguide 104, the second comparative waveguide 106, the first reference waveguide 110 and the second reference waveguide 108, the first light-combining component 28, the second light-combining component 112, the first detector waveguide 36, the second detector waveguide 38, the first auxiliary detector waveguide 114, the second auxiliary detector waveguide 116, the first light sensor 40, the second light sensor 42, the first auxiliary light sensor 118, and the second auxiliary light sensor 120. These optical components are configured and operated as disclosed above.

During operation, the reference signal carried on the reference waveguide 27 and the comparative signal carried on the comparative waveguide 30 are analog signals that each exits the LIDAR chip through an optical port 162. The communications link 156 includes a first optical fiber 164 that guides the comparative signal to the central electronics 158 and a second optical fiber 165 that guides the reference signal to the central electronics 158.

The central electronics 158 include a waveguide 170 that guides the comparative signal to the second splitter 100 which divides the comparative signal onto a first comparative waveguide 104 and a second comparative waveguide 106 as disclosed above. The first comparative waveguide 104 carries a first portion of the comparative signal to the first light-combining component 28. The second comparative waveguide 108 carries a second portion of the comparative signal to the second light-combining component 112. The central electronics 158 also include a waveguide 171 that guides the reference signal to the first splitter 102 which divides the reference onto the first reference waveguide 110 and the second reference waveguide 108. The first reference waveguide 110 carries a first portion of the reference signal to the first light-combining component 28. The second reference waveguide 108 carries a second portion of the reference signal to the second light-combining component 112.

The first light-combining component 28 combines the first portion of the comparative signal and the first portion of the reference signal into the first composite signal. The first light-combining component 28 also splits the first composite signal onto the first detector waveguide 36 and the second detector waveguide 38. The first detector waveguide 36 carries the first portion of the first composite signal to the first light sensor 40 that converts the first portion of the first composite signal to the first electrical signal. The second detector waveguide 38 carries a second portion of the composite signal to the second light sensor 42 that converts the second portion of the composite signal to a second electrical signal.

The second light-combining component 112 combines the second portion of the comparative signal and the second portion of the reference signal into a second composite signal. The light-combining component 112 also splits the second composite signal onto a first auxiliary detector waveguide 114 and a second auxiliary detector waveguide 116. The first auxiliary detector waveguide 114 carries the first portion of the second composite signal to the first auxiliary light sensor 118 that converts the first portion of the second composite signal to the first auxiliary electrical signal. The second auxiliary detector waveguide 116 carries the second portion of the second composite signal to a second auxiliary light sensor 120 that converts the second portion of the second composite signal to a second auxiliary electrical signal. The remote electronics process the first electrical signal, the second electrical signal, the first auxiliary electrical signal, and the second auxiliary electrical signal as described above.

When the optical components are selected such that the first composite signal and the second composite signal are generated on the remote electronics rather than on the LIDAR chip, the requirements for the lengths of the optical fibers in the communications link are less strict than when the first composite signal and the second composite signal are generated on the LIDAR chip. Where the first composite signal and the second composite signal are generated on the LIDAR chip and the balanced detectors are located on the remote electronics, the lengths of the optical fibers in the communications link 156 often need to be precisely controlled in order to preserve the desired phases at the balanced detectors.

Suitable electronics for inclusion in the electronics 62, the local electronics 160 and/or the central electronics 158 can include, but are not limited to, a controller that includes or consists of analog electrical circuits, digital electrical circuits, processors, microprocessors, digital signal processors (DSPs), computers, microcomputers, or combinations suitable for performing the operation, monitoring and control functions described above. In some instances, the controller has access to a memory that includes instructions to be executed by the controller during performance of the operation, control and monitoring functions. Although the electronics are illustrated as a single component in a single location, the electronics can include multiple different components that are independent of one another and/or placed in different locations. Additionally, as noted above, all or a portion of the disclosed electronics can be included on the chip including electronics that are integrated with the chip.

Although the laser cavity is shown as being positioned on the chip, all or a portion of the laser cavity can be located off the chip. For instance, the utility waveguide 16 can terminate at a second facet through which the outgoing LIDAR signal can enter the utility waveguide 16 from a laser cavity located off the chip.

The above chips can include components in addition to the illustrated components. As one example, optical attenuators (not illustrated) can be positioned along the first detector waveguide 36 and the second detector waveguide 38. The electronics can operate these attenuators so the power of the first portion of the composite signal that reaches the first light sensor 40 is the same or about the same as the power of the second portion of the composite signal that reaches the second light sensor 42. The electronics can operate the attenuators in response to output from the first light sensor 40 which indicates the power level of the first portion of the composite signal and the second light sensor 42 which indicates the power level of the second portion of the composite signal.

Although the optical sensor system is disclosed in the context of a vehicle such as car, the optical sensor system can be included in other vehicles. Suitable vehicles include, but are not limited to, trucks, boats, planes, spacecraft, and undersea craft. The vehicle need not be for transportation of people. For instance, the vehicle can be for the transportation of commercial goods, emergency food and medical supplies, and building materials. The optical sensor system can also be used in applications other than vehicles. For instance, the optical sensor system can be employed in other forms of autonomous mobile robots that do not carry people or goods but are used for numerous activities such as surveying, monitoring and maintenance.

Other embodiments, combinations and modifications of this invention will occur readily to those of ordinary skill in the art in view of these teachings. Therefore, this invention is to be limited only by the following claims, which include all such embodiments and modifications when viewed in conjunction with the above specification and accompanying drawings.

1. A LIDAR system, comprising:
a LIDAR chip that includes an optical port through which a light signal exits from the optical chip,
the light signal including data from which one or more components can be approximated, the one or more components selected from a group consisting of a relative distance between the LIDAR chip and an object located off the LIDAR chip, and a radial velocity between the object and the LIDAR chip.

2. The system of claim 1, wherein the light signal is an analog signal.

3. The system of claim 1, wherein the light signal includes light that was reflected off the object.

4. The system of claim 3, wherein the light signal includes light that was not reflected off the object.

5. The system of claim 1, wherein the light signal includes light that was not reflected off the object.

6. The system of claim 1, wherein the LIDAR chip is configured to generate an outgoing light signal and is configured such that the light signal includes light from the outgoing light signal that was not reflected off the object and also includes light from the outgoing light signal that was reflected off the object.

7. The system of claim 1, further comprising:
local electronics and central electronics, the central electronics being further from the LIDAR chip than the local electronics.

8. The system of claim 7, wherein an optical link provides optical communication between the central electronics and the LIDAR chip.

9. The system of claim 8, wherein the optical link includes one or more optical fibers that carry the light signal to the central electronics.

10. The system of claim 7, wherein the central electronics are configured to use the light signal to determine the relative distance between the object and/or a radial velocity between the object and the LIDAR chip.

11. The system of claim 7, wherein the LIDAR chip includes a light source;
the local electronics include a source control module configured to operate the light source such that the light source outputs an outgoing LIDAR signal;
the LIDAR chip is configured such that the light signal includes light from the outgoing light signal that was not reflected off the object and also includes light from the outgoing light signal that was reflected off the object; and
the central electronics are configured to use the light signal to determine the relative distance between the object and/or a radial velocity between the object and the LIDAR chip.

12. A LIDAR system, comprising:
a LIDAR chip that includes an optical port through which a light signal exits from the optical chip, the light signal including light reflected from an object off the chip.

13. The system of claim 12, wherein the light signal includes light that was not reflected off the object.

14. The system of claim 12, wherein the LIDAR chip is configured to generate an outgoing light signal and is configured such that the light signal includes light from the outgoing light signal that was not reflected off the object and also includes light from the outgoing light signal that was reflected off the object.

15. The system of claim 12, further comprising:
local electronics and central electronics, the central electronics being further from the LIDAR chip than the local electronics.

16. The system of claim 15, wherein an optical link provides optical communication between the central electronics and the LIDAR chip.

17. The system of claim 16, wherein the optical link includes one or more optical fibers that carry the light signal to the central electronics.

18. The system of claim 15, wherein the central electronics use the light signal to determine the relative distance between the object and/or a radial velocity between the object and the LIDAR chip.

19. The system of claim 15, wherein the LIDAR chip includes a light source;
the local electronics include a source control module configured to operate the light source such that the light source outputs an outgoing LIDAR signal;
the LIDAR chip is configured such that the light signal includes light from the outgoing light signal that was not reflected off the object and also includes light from the outgoing light signal that was reflected off the object; and
the central electronics are configured to use the light signal to determine the relative distance between the object and/or a radial velocity between the object and the LIDAR chip.

20. The system of claim 1, wherein the light signal is an analog signal.
